(19) United States
(12) Patent Application Publication
(10) Pub. No.: US 2003/0056377 A1
(43) Pub. Date: Mar. 27, 2003

(54) Hacksaw having a lock device for a quick release lever

(76) Inventor: Yin Han Huang, Taichung (TW)

Correspondence Address: Yin Han HUANG, No.108-24, Chong Chin Road, Bei Tun Chu, Taichung, 406, TW

(21) Appl. No.: 09/961,885

(22) Filed: Sep. 21, 2001

(51) Int. Cl. B27B 21/06

(52) U.S. Cl. 30/513; 30/507

(57) ABSTRACT

A hacksaw includes a saw blade detachably secured between a frame and a handle. An arm is rotatably secured to the lower portion of the handle, a lever is rotatably secured to the upper portion of the handle, and a rod received in the handle coupled between the lever and the arm. The lever is depressible to engage with the handle and to force the arm to engage with the handle, and to tension the saw blade between the frame and the handle. A lock device is slidably the handle and movable toward and away from the lever for selectively securing the lever to the handle.

### BACKGROUND OF THE INVENTION

1. Field of the Invention

The present invention relates to a hacksaw, and more particularly to a hacksaw including a lock device for locking the quick release lever of a quick release device.

2. Description of the Prior Art

Various kinds of typical hacksaws have been developed and comprise a quick release device including a quick release lever coupled to a saw blade, for quickly tensioning the saw blade and for locking the saw blade to the saw body. U.S. Pat. No. 4,571,829 to Withers, Jr., and U.S. Pat. No. 4,580,344 to Jinghage et al., disclose two of the typical hacksaws which also include a quick release lever of a quick release device coupled to a saw blade for quickly tensioning the saw blade and for locking the saw blade to the saw body. The quick release lever of the quick release device is normally folded to engage with the handle of the hacksaw, such that the users may hold or grasp the handle and the quick release lever simultaneously while conducting the sawing operations. However, no lock devices may be provided for locking the quick release lever to the handle, such that the users may have to tightly or solidly grasp the handle and the quick release lever simultaneously, and such that the hacksaw may not be effectively operated.

U.S. Pat. No. 4,466,471 to Thomson discloses the other typical hacksaw which includes a lock device for locking the quick release lever to the handle. However, a knob for switching the quick release lever is small and engaged within the handle and thus may not be easily operated.

U.S. Pat. No. 6,134,791 to the present applicant, Huang discloses a further typical hacksaw which also includes a lock device for locking the quick release lever to the handle. The lock device for the quick release lever is secured in the handle of the hacksaw where the hand or the palm of the users may hold or grasp the handle and may actuate or move the quick release lever inadvertently.

The present invention has arisen to mitigate and/or obviate the afore-described disadvantages of the conventional hacksaws.

### SUMMARY OF THE INVENTION

The primary objective of the present invention is to provide a hacksaw including a lock device for locking the quick release lever of a quick release device and for allowing the hacksaw to be effectively operated.

In accordance with one aspect of the invention, there is provided a hacksaw comprising a frame, a saw blade including a first end detachably secured to the frame, and including a second end, a handle secured to the frame, the handle including an upper portion and a lower portion, an arm rotatably secured to the lower portion of the handle, and including a first end for detachably securing to the second end of the saw blade, and including a second end, a lever rotatably secured to the upper portion of the handle, and including a first end and a second end, and a rod received in the handle, and including a lower portion secured to the second end of the arm, and including an upper portion secured to the first end of the lever. The second end of the lever is depressible toward and to engage with the upper portion of the handle, and to force the second end of the arm toward and to engage with the lower portion of the handle, and to tension and secure the saw blade between the frame and the handle.

A device is further provided for locking the lever to the handle and includes a lock device slidably engaged onto the upper portion of the handle and movable toward and away from the lever for selectively securing the lever to the handle and for preventing the lever from being operated or actuated inadvertently.

Another device is further provided for guiding the lock device to move toward and away from the lever, and includes at least one groove formed in the upper portion of the handle, the lock device includes at least one protrusion extended therefrom and slidably engaged into the groove of the handle, for guiding the lock device to move toward and away from the lever, and for selectively securing the lever to the handle. The lock device includes at least one ear dependent downward therefrom and having the protrusion extended from the ear for slidably engaged into the groove of the handle.

A still further device is further provided for limiting a movement of the lock device relative to the lever and the handle, and includes at least one stop extended from the handle for engaging with the lock device and for preventing the lock device from being disengaged from the handle.

The upper portion of the rod includes an orifice formed therein, the lever includes a pin engaged through the first end of the lever and the orifice of the rod for rotatably securing the upper portion of the rod to the first end of the lever. The rod includes an enlarged head provided on the upper portion thereof and having the orifice formed therein for receiving the pin.

An additional device is further provided for adjusting the rod relative to the arm and includes an outer thread formed on the lower portion of the rod and engaged through the second end of the arm, and a fastener threaded to the outer thread of the rod and engaged with the second end of the arm and adjustable relative to the rod, for adjusting the rod relative to the handle and the second end of the arm. The second end of the arm includes an oblong hole formed therein for slidably receiving the lower portion of the rod and.

The upper portion of the handle includes a recess formed therein for receiving the lever and for preventing the lever from being actuated inadvertently.

The handle includes a channel formed therein for receiving the rod and for preventing the rod from being actuated inadvertently. The handle includes a rear portion having a hand grip provided therein, and having the channel formed in the hand grip thereof.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a hacksaw in accordance with the present invention;

FIG. 2 is a partial exploded view of the hacksaw;

FIG. 3 is a partial cross sectional view taken along lines 3-3 of FIG. 1;

FIG. 4 is a plan schematic view of the hacksaw; and

FIG. 5 is a plan schematic view similar to FIG. 4, illustrating the operation of the hacksaw.

### DETAILED DESCRIPTION OF THE PREFERRED EMBODIMENT

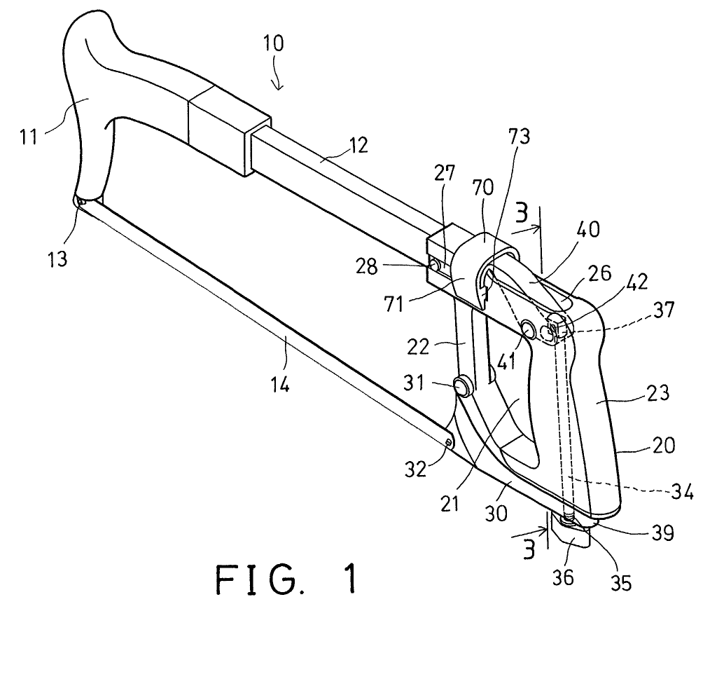

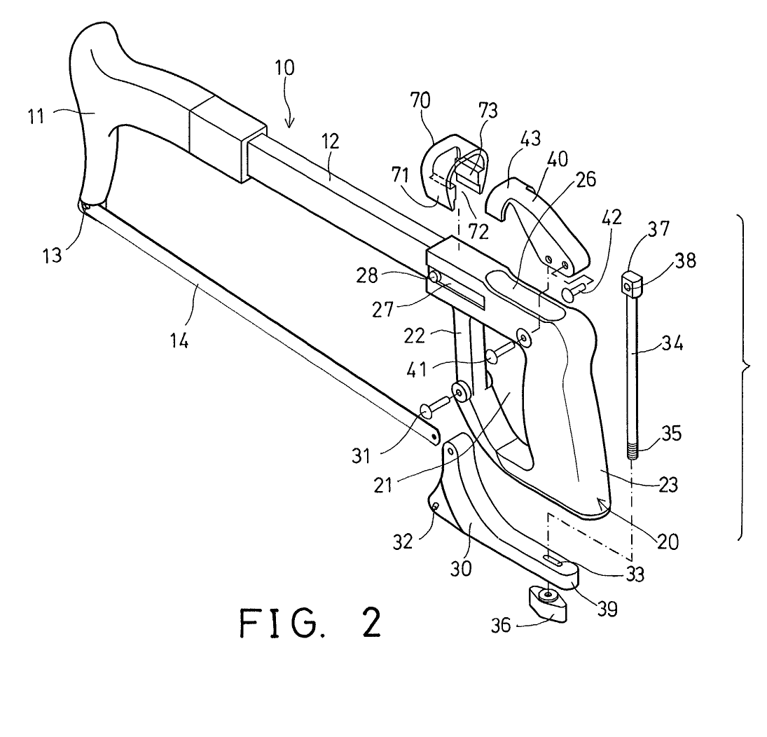

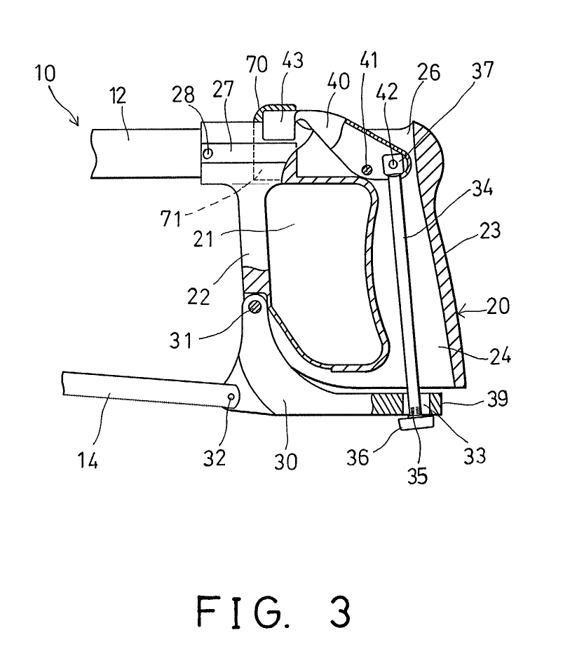

Referring to the drawings, and initially to FIGS. 1-4, a hacksaw in accordance with the present invention comprises a body 10 including a frame 11 provided in the front portion and extended from or secured to a beam 12, and including a handle 20. The beam 12 is secured between the upper portions of the frame 11 and the handle 20, for example. Alternatively, the frame 11 may also be directly secured to the handle 20. The frame 11 includes a lower portion having a projection 13 for engaging with one end hole of a blade 14. The handle 20 includes an opening 21 formed therein for receiving the fingers of the users, and includes a beam 22 and a hand grip 23 formed or provided in the front and the rear portion of the opening 21 thereof. The handle 20 includes a channel 24 formed in the hand grip 23, and includes a recess 26 formed in the upper portion thereof and communicating with the channel 24 of the hand grip 23. The handle 20 further includes one or two grooves 27 formed in either or both sides of the upper portion thereof, and includes one or two stops 28 secured or provided or extended in the front end of the respective grooves 27 of the handle 20.

An arm 30 includes a middle portion rotatably or pivotally coupled to the front portion of the handle 20, such as coupled to the beam 22 of the handle 20 with a pivot shaft 31 for allowing the arm 30 to be rotated relative to the handle 20 about the pivot shaft 31. The arm includes one end, such as the front and lower end portion having another projection 32 extended or provided thereon for engaging with the other end hole of the blade 14, and for releasably securing the blade 14 between the frame 11 and the handle 20. For example, the blade 14 may be solidly or firmly secured between the frame 11 and the handle 20 when the arm 30 is rotated away from the blade 14 or rotated to engage with the lower portion of the handle 20. On the contrary, the blade 14 may be released when the arm 30 is rotated toward the blade 14 or rotated away or disengaged from the lower portion of the handle 20. The arm 30 includes the other end, such as the rear end 39 having an oblong hole 33 formed therein.

A rod 34 is slidably received in the channel 24 of the hand grip 23, and includes an outer thread 35 provided or formed on the lower portion thereof and engaged through the oblong hole 33 of the arm 30, for threading to a wing nut or a lock nut or a fastener 36 or the like. The fastener 36 may be rotated relative to the rod 34 for adjusting the rod 34 relative to the handle 20. The rod 34 includes an upper end having an enlarged head 37 formed or provided thereon. The enlarged head 37 of the rod 34 includes an orifice 38 formed therein.

A lever 40 is partially received in the recess 26 of the handle 20, and includes such as a lower and middle portion rotatably or pivotally coupled to the upper portion of the handle 20, such as coupled to the adjacent portion of the hand grip 23 and the upper portion of the handle 20 with a pivot axle 41 for allowing the lever 40 to be rotated relative to the handle 20 about the pivot axle 41. The lever 40 includes one end, such as the rear end thereof rotatably or pivotally coupled to the upper end or the enlarged head 37 of the rod 34 with a pin 42 which is engaged through the orifice 38 of the enlarged head 37 of the rod 34. The rear end 39 of the arm 30 may thus be moved toward or away from the handle 20 by the lever 40 with the rod 34 when the lever 40 is rotated relative to the handle 20 about the pivot axle 41. The lever 40 includes the other end, such as the front end thereof having a knob 43 formed or provided thereon for rotating the lever 40 relative to the handle 20 about the pivot axle 41.

A lock device 70 includes a substantially inverted U-shape having a pair of downwardly dependent ears 71 for forming or defining a space 72 between the ears 71, and for slidably engaging onto the side portions of the handle 20, particularly the upper and side portions of the handle 20. The ears 71 of the lock device 70 each includes a protrusion 73 extended therefrom, such as extended inward of the space 72 of the lock device 70, and slidably engaged in the grooves 27 of the handle 20 respectively, for guiding the lock device 70 to move toward or away from the knob 43 of the lever 40. The knob 43 of the lever 40 may be engaged into the space 72 of the lock device 70 when the lock device 70 is moved toward the knob 43 of the lever 40, and may be disengaged from the lock device 70 when the lock device 70 is moved away from the knob 43 of the lever 40. The stops 28 of the handle 20 may engage with the lock device 70, such as the protrusions 73 of the lock device 70, for limiting the relative movement between the lock device 70 and the handle 20 and for preventing the lock device 70 from being disengaged from the handle 20 inadvertently.

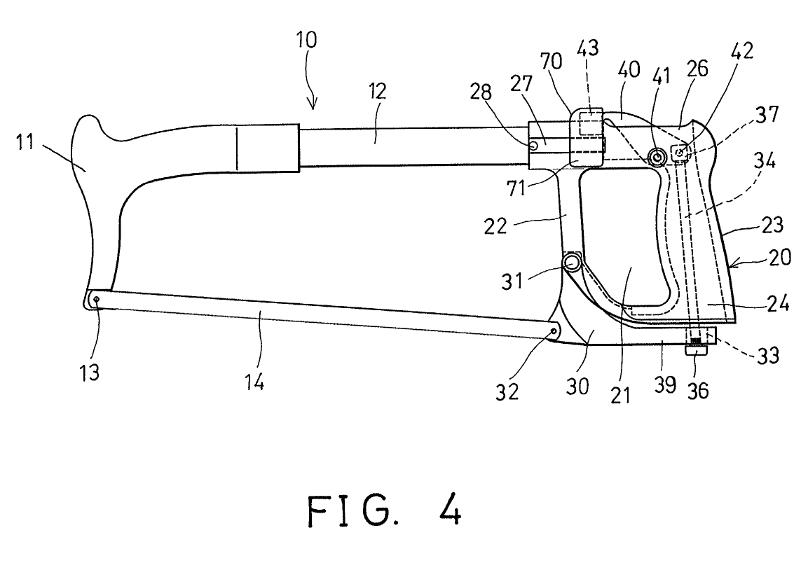

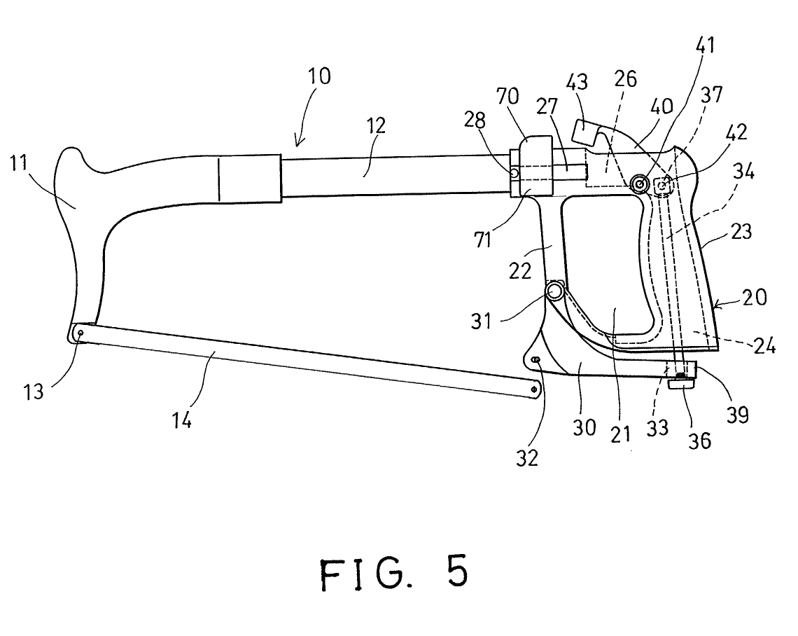

In operation, as shown in FIG. 4, the lock device 70 may be moved toward the knob 43 of the lever 40 to engage the knob 43 of the lever 40 into the space 72 of the lock device 70, and to solidly lock the lever 40 to the handle 20. The lock device 70 may also be moved away from the knob 43 of the lever 40 to disengage the knob 43 of the lever 40 from the lock device 70, and to release the lever 40 from the handle 20 (FIG. 5).

When the lever 40 is released and before the saw blade 14 is secured to the handle 20 with the arm 30, the fastener 36 may be rotated relative to the rod 34 for adjusting the rod 34 relative to the handle 20, and for adjusting the tensioning force of the saw blade 14, and for suitably tensioning and securing the saw blade 14 between the frame 11 and the handle 20. A spring biasing member (not shown) may be provided and engaged between the lock device 70 and the handle 20, for biasing the lock device 70 to move toward the knob 43 of the lever 40 and to engage the knob 43 of the lever 40 into the space 72 of the lock device 70, and to solidly lock the lever 40 to the handle 20.

It is to be noted that the rod 34 is received in the channel 24 of the hand grip 23 and thus will not be moved or contacted or actuated by the users inadvertently. It is further to be noted that the lever 40 is partially received in the recess 26 of the handle 20, and includes only the knob 43 extended outward of the handle 20, such that the lever 40 will not be actuated or operated inadvertently and may be prevented from being actuated or operated inadvertently. Furthermore, the lock device 70 is engaged onto the upper and the side portions of the handle 20 and may thus be easily operated and moved relative to the handle 20 and toward and away from the knob 43 of the lever 40 by the users. The channel 24 of the hand grip 23 may be opened rearward for allowing the rod 34 to be seen through the channel 24 of the hand grip 23. and also for preventing the rod 34 from being contacted or actuated by the hands of the users.

None of the prior hacksaw includes a lever 40 rotatably or pivotally secured on the upper portion of the handle 20 and rotatable to engage with the upper portion of the handle 20 and selectively lockable to the handle 20 with the lock device 70. The provision of the lock device in accordance with the present invention may further be used for solidly securing the lock device 70 to the handle 20.

Accordingly, the hacksaw in accordance with the present invention includes a lock device for locking the quick release lever of a quick release device and for allowing the hacksaw to be effectively operated.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A hacksaw comprising:
a frame,
a saw blade including a first end detachably secured to said frame, and including a second end,
a handle secured to said frame, said handle including an upper portion and a lower portion,
an arm rotatably secured to said lower portion of said handle, and including a first end for detachably securing to said second end of said saw blade, and including a second end,
a lever rotatably secured to said upper portion of said handle, and including a first end and a second end, and
a rod received in said handle, and including a lower portion secured to said second end of said arm, and including an upper portion secured to said first end of said lever,
said second end of said lever being depressible toward and to engage with said upper portion of said handle, and to force said second end of said arm toward and to engage with said lower portion of said handle, and to tension and secure said saw blade between said frame and said handle.

2. The hacksaw according to claim 1 further comprising means for locking said lever to said handle.

3. The hacksaw according to claim 2, wherein said locking means includes a lock device slidably engaged onto said upper portion of said handle and movable toward and away from said lever for selectively securing said lever to said handle.

4. The hacksaw according to claim 3 further comprising means for guiding said lock device to move toward and away from said lever.

5. The hacksaw according to claim 4, wherein said guiding means includes at least one groove formed in said upper portion of said handle, said lock device includes at least one protrusion extended therefrom and slidably engaged into said at least one groove of said handle, for guiding said lock device to move toward and away from said lever, and for selectively securing said lever to said handle.

6. The hacksaw according to claim 5, wherein said lock device includes at least one ear dependent downward therefrom and having said at least one protrusion extended from said at least one ear.

7. The hacksaw according to claim 3 further comprising means for limiting a movement of said lock device relative to said lever and said handle.

8. The hacksaw according to claim 7, wherein said limiting means includes at least one stop extended from said handle for engaging with said lock device and for preventing said lock device from being disengaged from said handle.

9. The hacksaw according to claim 1, wherein said upper portion of said rod includes an orifice formed therein, said lever includes a pin engaged through said first end of said lever and said orifice of said rod for rotatably securing said upper portion of said rod to said first end of said lever.

10. The hacksaw according to claim 9, wherein said rod includes an enlarged head provided on said upper portion thereof and having said orifice formed therein for receiving said pin.

11. The hacksaw according to claim 1 further comprising means for adjusting said rod relative to said arm.

12. The hacksaw according to claim 11, wherein said adjusting means includes an outer thread formed on said lower portion of said rod and engaged through said second end of said arm, and a fastener threaded to said outer thread of said rod and engaged with said second end of said arm and adjustable relative to said rod, for adjusting said rod relative to said handle and said second end of said arm.

13. The hacksaw according to claim 12, wherein said second end of said arm includes an oblong hole formed therein for slidably receiving said lower portion of said rod and.

14. The hacksaw according to claim 1, wherein said upper portion of said handle includes a recess formed therein for receiving said lever and for preventing said lever from being actuated inadvertently.

15. The hacksaw according to claim 1, wherein said handle includes a channel formed therein for receiving said rod and for preventing said rod from being actuated inadvertently.

16. The hacksaw according to claim 15, wherein said handle includes a rear portion having a hand grip provided therein, and having said channel formed in said hand grip thereof.
